(19) United States
(12) Patent Application Publication
(10) Pub. No.: US 2025/0327752 A1
(43) Pub. Date: Oct. 23, 2025

(54) RAMAN SPECTROSCOPIC SYSTEM FOR DETECTING HUMAN BODY FLUID TRACES ON AN INTERFERING SUBSTRATE

(71) Applicant: The Research Foundation for the State University of New York, Albany, NY (US)

(72) Inventors: Igor K. Lednev, Albany, NY (US); Yury V. Kistenev, Tomsk (RU); Alexei V. Borisov, Tomsk (RU)

(21) Appl. No.: 19/098,597

(22) Filed: Apr. 2, 2025

Related U.S. Application Data
(60) Provisional application No. 63/573,182, filed on Apr. 2, 2024.

(51) Int. Cl. G01N 21/65; G01N 21/3504

(52) U.S. Cl. CPC G01N 21/65; G01N 21/3504; G01N 2201/0221

(57) ABSTRACT

A system and method for detecting human body fluid traces within a fluid sample on a substrate that interferes with the analysis of the light scatter in Raman spectroscopy. Two methods can be used to account for the light scatter: reductive removal of the scatter data from the spectroscopic data, e.g. “reducing a spectrum complexity” (RSC); and including the scatter data in the spectroscopic data and identifying it, e.g. “Multivariate curve resolution combined with the additions method” (MCRAD). The system can include a remote Raman spectrometer that can utilize locate and remote computer assets to assist in the remote detection of human body fluid traces, such as blood or semen.

### CROSS-REFERENCE TO RELATED APPLICATION

This invention claims the benefit of US Provision Patent Application No. 63/573,182, filed Apr. 2, 2024, the entirety of which is hereby incorporated herein by this reference.

### STATEMENT REGARDING FEDERALLY SPONSORED RESEARCH

This invention was made with government support under grant number 2052030, awarded by the National Science Foundation. The government has certain rights in the invention.

### BACKGROUND OF THE INVENTION

### 1. Field of the Invention

The present invention generally relates to Raman spectroscopy and non-destructive chemical analysis. More particularly, the present invention relates to a system and method to detect human fluid traces, such as blood or semen, on a substrate that can interfere with the light scatter.

### 2. Description of the Related Art

Body fluid traces discovered at a crime scene play a significant role in reconstructing the event and are the primary source of DNA, RNA, etc. The majority of current methods for body fluid detection and identification are based on biochemical reactions. Several presumptive and confirmatory tests have been developed for bloodstains, which are often found at the scenes of violent crimes. Presumptive blood tests, which can be conducted at the scene, are mainly based on the peroxidase atalysis of hemoglobin (Hb) from red blood cells. These tests can potentially result in false positives caused by environmental oxidants. Confirmatory tests for blood, including Teichmann and Takayama hemoglobin crystal tests, and immunological tests, such as ELISA and LDH assays, are labor intensive and costly and require a laboratory environment’. Several emerging technologies have been recently developed for body fluid identification, including blood.

With respect to the detection of semen, the male reproductive fluid, which is especially important as evidence in sexual assault cases, the identification of semen at the scene and later extraction for DNA is extremely importance. Current methods for semen stain identification at a crime scene rely on proteins like prostate-specific antigen (PSA) and semenogelin I and II (SgI/II) as well as sperm, the most unique part of semen. Sperm cells are not present in other body fluid, and so their presence is the most reliable means of semen identification. However, sperm cells are not present in all semen, or they can be in low concentrations, or degraded and therefore hard to find.

Other methods involve the identification of human semen proteins using immunochromatographic methods. The protein PSA is used in the ABAcard® p30 immunochromatography cartridge, while RSID™-Semen uses SgI/II, to identify the presence of semen. It was thought that PSA and SgI/II were unique to semen, but both have been found in other tissues and organs. Consequently, PSA is not a very reliable indication of the presence of semen.

Liquid chromatography-mass spectrometry and capillary electrophoresis can provide confirmatory identification of all main body fluids. However, these tests are time-consuming and require extensive sample preparation and a laboratory setting. The analysis of mRNA expression has also been introduced in forensic science as a tool to identify body fluids and tissues due to its specificity and sensitivity by targeting RNA sequencing of upregulated biomarkers. These RNA assays have successfully expanded into the study of multiplex body fluid samples potentially found in sexual assault cases. However, many of these methods necessitate the destruction of evidence for testing. Therefore, an abundance of research has been conducted on alternative methods of body fluid identification that do not rely on non-specific proteins and are not destructive in nature.

Spectroscopic methods such as IR, UV-Vis absorption, and fluorescence have been shown to have great potential for detecting and identifying body fluid traces. These techniques are nondestructive and could be applied at a crime scene since portable commercial instruments are available. Among these new methods, Raman spectroscopy is gaining interest as a universal, confirmatory method for the identification of all forensically relevant body fluids due to its specificity, ease of use, required minimal sample preparation, and possibility of being conducted at the scene of a crime.

The benefits of Raman spectroscopy in forensics include the possibility to work with a small amount of material, as low as several picograms or femtoliters, high sensitivity to a sample's chemical composition and structure, and a noncontacting and nondestructive method of analysis. Raman spectroscopy is already used by law enforcement agencies for confirmatory drug identification, trace evidence, paint and fiber analysis, etc. Chemometric analysis combined with Raman spectroscopy allows for the confirmatory identification of bloodstains, determining the time since deposition differentiating human and animal blood and providing phenotypic information about the donor.

The specificity of body fluid trace detection at a crime scene can be affected by an underlying surface (substrate) such as floor tile, paper tissue, or contaminants, which can contribute to Raman scattering. The substrate's surface energy, the interaction between the body fluid and substrate, determines the wetting and affects the final morphology of the dried biofilm. A substrate can produce Raman scattering that is stronger by orders of magnitude compared to a body fluid signal.

A popular experimental approach to avoid substrate interference is restoring an initial state of body fluid by a sample soluting in water. However, this is time-consuming and destructive because adding water to dried body fluid, accompanied by chemical reactions, can affect Raman spectra. Therefore, a significant problem of body fluid trace identification is the interference from the detecting light scatter from a substrate. To implement Raman spectroscopy in practical forensics, the interference signal from common substrates must be addressed.

### BRIEF SUMMARY OF THE INVENTION

The present invention provides a system and method to account for common substrate interference with the light scatter used for Raman spectroscopic analysis of fluid samples. There are two approaches to dealing with the noise in the light scatter caused by the substrate, such as removing it through a process such as “reducing a spectrum complexity” (RSC), and accounting for the noise, such as with a “Multivariate curve resolution combined with the additions method” (MC RAD). The use of these methods within the system can provide more accurate chemical analysis of fluid samples which is particularly advantageous in detecting the presence of human blood, as well as gathering other data about the human blood sample.

In one embodiment, the invention provides a system to perform spectroscopic analysis on a fluid sample on an interfering substrate that includes a Raman spectrometer which has a body thereof. The body includes a computer platform in selective communication, across a network, with other computer devices. A spectrometer is in the body and selectively receives and records a light scatter, and a laser selectively projects a sensing laser light. There is a focusing optic through which passes the sensing laser light and the light scatter and a processor in selective communication with the computer platform of the body across a network. The spectrometer selectively probes a remote fluid sample on a substrate that produces interfering light scatter thereby obtaining spectroscopic data therefrom that contains the interfering light scatter, and the spectrometer further relays the spectroscopic data to the processor for analysis. The processor is configured to isolate the interfering light scatter from the spectroscopic data to thereby produce chemical analysis data for the fluid sample.

The processor can be further configured to produce chemical analysis data by including the interfering light scatter as a component with the chemical analysis data. When the processor is configured to produce chemical analysis data by including the interfering light scatter as a component with the chemical analysis data, the processor can perform a multivariate curve resolution on the spectroscopic data based on a bilinear model of a complex mixture spectrum. In an embodiment, the processor can further determine a component concentration in the spectroscopic data from a predetermined IR absorption spectrum of a complex gas mixture.

There can be a data store in selective communication with the processor and the computer platform of the spectrometer. When the fluid sample is human blood, the processor can then be further configured to produce chemical analysis data for human blood. The fluid sample can contain other human trace fluids such as semen. Additionally, the processor can be located remotely from the spectrometer and also store chemical analysis data at the data store.

In one embodiment, the invention includes a method of utilizing Raman spectroscopy to detect and identify a fluid sample on a light scattering substrate by scanning a fluid sample with a portable Raman spectrometer, which has a body thereof including a computer platform in selective communication with other computer devices across a network, and the Raman spectrometer selectively receiving and recording a light scatter from a laser selectively projecting a sensing laser. The method continues with collecting spectroscopic data from a fluid sample at the computer platform of the spectrometer with the fluid sample being upon a light scattering substrate. Then transmitting the spectroscopic data from the computer platform of the spectrometer to a processor across a network with the processor in selective communication with the computer platform of the body across the network. The method continues with analyzing the received spectroscopic data at the processor and isolating the interfering light scatter from the spectroscopic data to thereby produce chemical analysis data for the fluid sample. The present method can detect the presence of human blood and/or semen and also perform the requisite chemical analysis.

In an embodiment, the invention includes a device for detecting blood traces on a fluid sample on an interfering substrate, where in the device includes a body that has a computer platform in selective communication with a network. There is a spectrometer in the body that selectively receives and records a light scatter, and a laser selectively projects a sensing laser light that can be targeted on a fluid sample. The body includes a focusing optic through which passes the sensing laser light and the light scatter, and the spectrometer projects the sensing laser light to selectively probe a remote fluid sample on a substrate that produces interfering light scatter. The spectrometer thereby obtains spectroscopic data from the fluid sample that contains the interfering light scatter and the spectroscopic data is relayed to the computer platform for analysis. The computer platform is further configured to isolate the interfering light scatter from the spectroscopic data to thereby produce chemical analysis data for the fluid sample.

The present invention provides advantages in having the ability to work with trace amounts of a fluid sample to detect the presence of human fluids, such as blood or semen, a high chemical specificity, no need for sample preparation, and non-destructive or alterative testing of a fluid sample. The present invention is industrially applicable in that it provides testing equipment that can use Raman spectroscopy to remotely test fluid samples to determine their chemical composition. Other advantages and features of the present invention will be apparent to one of skill in the art after review of the present application.

### BRIEF DESCRIPTION OF THE DRAWINGS

FIG. 1 is a diagram of one embodiment of a system for remote chemical analysis of a fluid sample on an interfering substrate by a portable Raman spectroscopy device.

FIG. 2 is a graph of Manne condition in a concentration space.

FIG. 3 is a graph of the functional dependence on variable parameter Ĉ.

FIG. 4A is a graph of selected Raman spectra of pure blue polyester, denim, cotton fabric, and white polyester substrates.

FIG. 4B is a graph of the bloodstains on Al foil on the same pure substrates as FIG. 4A.

FIG. 5A is a graph of the blood volume fraction restored by MCRAD and RSC in experimental Raman spectra of bloodstains on a blue polyester substrate.

FIG. 5B is a graph of the blood volume fraction restored by MCRAD and RSC in experimental Raman spectra of bloodstains on a denim substrate.

FIG. 5C is a graph of the blood volume fraction restored by MCRAD and RSC in experimental Raman spectra of bloodstains on a cotton fabric substrate.

FIG. 5D is a graph of the blood volume fraction restored by MCRAD and RSC in experimental Raman spectra of bloodstains on a polyester substrate.

FIG. 6A is a graph of the blood volume fraction restored by MCRAD and RSC in experimental Raman spectra of bloodstains on a blue polyester pure substrate.

FIG. 6B is a graph of the blood volume fraction restored by MCRAD and RSC in experimental Raman spectra of bloodstains on a denim pure substrate.

FIG. 6C is a graph of the blood volume fraction restored by MCRAD and RSC in experimental Raman spectra of bloodstains on a cotton fabric pure substrate.

FIG. 6D is a graph of the blood volume fraction restored by MCRAD and RSC in experimental Raman spectra of bloodstains on a polyester pure substrate.

FIG. 7 is a graph of the calculated dependence of the Soergel distance S₁ on the number of points in the sliding spectral window for bloodstain spectra on Al foil and common substrates.

FIG. 8A is a graph of the results of the Soergel distance calculations in an individual sliding spectral window for various Raman bands with the distance is presented in terms of mean values between the Raman spectra of blood on Al foil and a pure blue polyester substrate.

FIG. 8B is a graph of the results of the Soergel distance calculations in an individual sliding spectral window for various Raman bands with the distance is presented in terms of mean values between the Raman spectra of blood on Al foil and a denim substrate.

FIG. 8C is a graph of the results of the Soergel distance calculations in an individual sliding spectral window for various Raman bands with the distance is presented in terms of mean values between the Raman spectra of blood on Al foil and a cotton fabric substrate.

FIG. 8D is a graph of the results of the Soergel distance calculations in an individual sliding spectral window for various Raman bands with the distance is presented in terms of mean values between the Raman spectra of blood on Al foil and a white polyester substrate.

FIG. 9 is a graph of the dependence of the target component (blood) volume fraction restoration error on the additive noise amplitude.

FIG. 10 is a graph of the dependence of the target component (blood) volume fraction restoration error on the additive noise amplitude.

FIG. 11A is a graph of probability density distribution of the proximity factor for the residuals between the experimental Raman spectra of blood stain on a definite substrate of blue polyester.

FIG. 11B is a graph of probability density distribution of the proximity factor for the residuals between the experimental Raman spectra of blood stain on a definite substrate of denim.

FIG. 11C is a graph of probability density distribution of the proximity factor for the residuals between the experimental Raman spectra of blood stain on a definite substrate of cotton fabric.

FIG. 11D is a graph of probability density distribution of the proximity factor for the residuals between the experimental Raman spectra of blood stain on a definite substrate of white polyester.

FIG. 12A is a graph of Raman spectral data obtained for an apparent bloodstain are statistically compared with Raman spectra obtained for a pure substrate of blue polyester.

FIG. 12B is a graph of Raman spectral data obtained for an apparent bloodstain are statistically compared with Raman spectra obtained for a pure substrate of denim.

FIG. 12C is a graph of Raman spectral data obtained for an apparent bloodstain are statistically compared with Raman spectra obtained for a pure substrate of cotton fabric.

FIG. 12D is a graph of Raman spectral data obtained for an apparent bloodstain are statistically compared with Raman spectra obtained for a pure substrate of white polyester.

FIG. 13A is a graph of the dependence of r on the gliding spectral window for Raman spectra of blood on various substrates processing by a Savitsky-Goley filter.

FIG. 13B is a graph of the dependence of r on the gliding spectral window for Raman spectra of pure substrates processing by a Savitsky-Goley filter.

FIG. 14A is a graph of the dependence of on the polynomial order for Raman spectra of blood on Al substrate and a blue polyester substrate.

FIG. 14B is a graph of the dependence of on the polynomial order for Raman spectra of blood on Al substrate and a pure blue polyester substrate.

FIG. 14C is a graph of the dependence of on the polynomial order for Raman spectra of blood on Al substrate and processing by Savitsky-Goley filter.

FIG. 15 is a representative diagram of the typical Raman spectra shift of a semen stain on an Al foil substrate with illustrative graphs of the Raman intensity.

FIG. 16A is a graph of the spatially averaged Raman spectra of polyester before baseline correction.

FIG. 16B is a graph of the spatially averaged Raman spectra of glass before baseline correction.

FIG. 16C is a graph of the spatially averaged Raman spectra of seminal fluid on an aluminum substrate before baseline correction.

FIG. 16D is a graph of the spatially averaged Raman spectra of polyester of FIG. 16A after the baseline correction.

FIG. 16E is a graph of the spatially averaged Raman spectra of glass of FIG. 16B after baseline correction.

FIG. 16F is a graph of the spatially averaged Raman spectra of seminal fluid on an aluminum substrate of FIG. 16C after baseline correction.

FIG. 17A is a graph of the spatial averaged (with standard deviation) Raman spectra of polyester after baseline correction.

FIG. 17B is a graph of the spatial averaged (with standard deviation) Raman spectra of glass after baseline correction.

FIG. 17C is a graph of the spatial averaged (with standard deviation) Raman spectra of seminal fluid on an aluminum substrate after baseline correction.

FIG. 18A is a graph of the dependence of the residual σ for the RSC method for semen on a polyester substrate.

FIG. 18B is a graph of the dependence of the residual σ for the RSC method for semen on a glass substrate.

FIG. 18C is a graph of the dependence of the residual σ for the MCRAD method for semen on a polyester substrate.

FIG. 18D is a graph of the dependence of the residual σ for the MCRAD method for semen on a glass substrate.

FIG. 19A is a graph of the dependences of the C_{found}=\tilde{C} restored by the RSC (stars ‘*’) and MCRAD (blue circles) for a polyester substrate with N=0 (a).

FIG. 19B is a graph of the dependences of the C_{found}=\tilde{C} restored by the RSC (stars ‘*’) and MCRAD (blue circles) for a polyester substrate with N=0.01 (b).

FIG. 19C is a graph of the dependences of the C_{found}=\tilde{C} restored by the RSC (stars ‘*’) and MCRAD (blue circles) for a glass substrate with N=0.01 (c). FIGS. (d-f) show the relative residuals.

FIG. 19D is a graph of the relative residuals of the dependences of the C_{found}=Ć in FIG. 19A.

FIG. 19E is a graph of the relative residuals of the dependences of the C_{found}=\tilde{C} in FIG. 19B.

FIG. 19F is a graph of the relative residuals of the dependences of the C_{found}=Ć in FIG. 19C.

FIG. 20A is a graph taking into account spatial variations of the semen reference Raman spectra and using the averaged polyester substrate spectrum (S_{ref} is not varied, S_{ref,e} is varied).

FIG. 20B is a graph taking into account spatial variations of polyester substrate spectra and using the averaged semen spectrum (S_{ref}, S_{ref,e} are not varied, a substrate Raman spectrum is varied).

FIG. 20C is a graph taking into account spatial variations of both the semen reference and polyester substrate Raman spectra (S_{ref}, S_{ref,r}, and a substrate Raman spectrum are varied).

FIG. 20D is a graph taking into account spatial variations of the semen reference spectra and using the averaged glass substrate spectrum (S_{ref} is not varied, S_{ref,r} is varied).

FIG. 20E is a graph taking into account spatial variations of glass substrate spectra and using the averaged semen reference Raman spectrum (S_{ref}, S_{ref,r} are not varied, a substrate Raman spectrum is varied).

FIG. 20F is a graph taking into account spatial variations of both the semen reference and glass substrate Raman spectra (S_{ref}, S_{ref,r} and substrate Raman spectra are varied).

FIG. 20G is a graph of the relative error corresponding to FIG. 20C.

FIG. 20H is a graph of the relative error corresponding to FIG. 20F.

FIG. 21A is a graph of experimental Raman spectra of semen dried on a polyester substrate.

FIG. 21B is a graph of experimental Raman spectra of semen dried on a glass substrate.

FIG. 22A is a graph of a restored semen VF distribution density at a certain spatial point by MCRAD (light) and RSC (dark) on a polyester substrate.

FIG. 22B is a graph of a restored semen VF distribution density at a certain spatial point by MCRAD (light) and RSC (dark) on a glass substrate.

FIG. 22C is a graph of the semen VF distribution density averaged over all studied points on a polyester substate surface restored by MCRAD (light) and RSC (dark).

FIG. 22D is a graph of the semen VF distribution density averaged over all studied points on a glass substrate surface restored by MCRAD (light) and RSC (dark).

FIG. 23A is a graph of average values of a at various spatial points on a sample of a semen stain on a polyester substrate.

FIG. 23B is a graph of average values of a at various spatial points on a sample of a semen stain on a glass substrate.

FIG. 24A is a graph of an estimation of the probability of restoring C_{ref}, C_{blank} true VFs by the RSC/MCRAD, using every combination of a reference semen Raman spectrum with a Raman spectrum of a pure polyester substrate.

FIG. 24B is a graph of an estimation of the probability of restoring C_{ref}, C_{blank} true VFs by the RSC/MCRAD, using every combination of a reference semen Raman spectrum with a Raman spectrum of a pure glass substrate.

FIG. 24C is a graph of an estimation of the probability of restoring C_{ref}, C_{blank} true VFs by the RSC/MCRAD at various spatial points on a sample of a semen stain on a polyester substrate.

FIG. 24D is a graph of an estimation of the probability of restoring C_{ref}, C_{blank} true VFs by the RSC/MCRAD at various spatial points on a sample of a semen stain on a glass substrate.

### DETAILED DESCRIPTION OF THE INVENTION

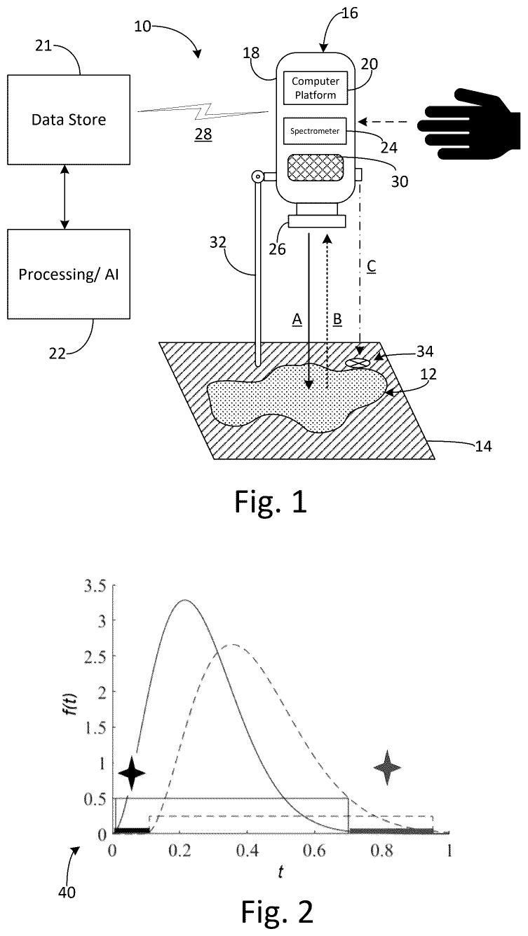

With reference to the figures in which like numerals represent like elements throughout the several views, FIG. 1 is a diagram of one embodiment of a system 10 for remote chemical analysis of a fluid sample 12 on an interfering substrate 14 by a portable Raman spectroscopy device 16. The system 10 has a body 18 thereof that includes a computer platform 20, which can include a processer, in selective communication, across a network 28, with other computer devices, such as a data store 20 and remote processing 22. A spectrometer 24 is in the body 18 and selectively receives and records a light scatter (arrow B), and a laser selectively projects a sensing laser light (Arrow A). There is a focusing optic 26 through which passes the sensing laser light (Arrow A) and the light scatter (Arrow B). The spectrometer 24 selectively probes a remote fluid sample 12 on a substrate 14 that produces interfering light scatter within light scatter (Arrow B) thereby obtaining spectroscopic data therefrom that contains the interfering light scatter, and the spectrometer 24 further relays the spectroscopic data to the processor, either at the computer platform 20 or the remote processing 22, for analysis. The processor is configured to isolate the interfering light scatter from the spectroscopic data to thereby produce chemical analysis data for the fluid sample 12.

The processor, either on the computer platform 20 or at remote processing 22, can be further configured to produce chemical analysis data by including the interfering light scatter as a component with the chemical analysis data, as is further described herein. When the processor is configured to produce chemical analysis data by including the interfering light scatter as a component with the chemical analysis data, the processor can perform a multivariate curve resolution on the spectroscopic data based on a bilinear model of a complex mixture spectrum, as is further described herein. The processor can further determine a component concentration in the spectroscopic data from a predetermined IR absorption spectrum of a complex gas mixture.

There can be a data store 21 in selective communication with the processor and the computer platform 20 and the spectrometer 24. When the fluid sample 12 is human blood, the processor can then be further configured to produce chemical analysis data for human blood. The fluid sample 12 can contain other human trace fluids such as semen. Additionally, the processor can be located remotely from the spectrometer, such as remote processing 22 and also store chemical analysis data at the data store 21, or send the analysis for display 30 at the body 18.

Among all types of body fluids, blood is commonly found in crime scene investigations involving violence. Therefore, the present system is effective in the analysis of peripheral blood stains using a hand-held Raman spectrometer 16, which can be coupled with stand-off attachment (physical attachment 21 or visual light projection 34) via visual and statistical analysis of Rama spectral data.

Thus, in one embodiment, the portable Raman spectrometer 16 includes an optimal distancing device connected to the body 18 that visually indicates a predetermined optimal distance for probing a fluid sample 12 with spectroscopy. In one embodiment, the optimal distance device is a physical attachment 32 to the body 18, shown here as a swinging ruler that indicates the optimal distance by having a far end positioned proximate to the fluid sample 12. Alternately, the optimal distance device can be a light projection (Line C) from the body 18. In such embodiment, the light projection (Line C) projects a light target 34 that appears clear at the optimal distance of the lens 56 from the fluid sample 60 for optimal Raman spectroscopy.

The computer platform 44 can be configured to be connected to a data store 52 and selectively relay scanned spectroscopic data thereto. Further, the spectrometer 24 can use an orbital raster scan mode to probe the fluid sample 12. Additionally, the spectrometer 24 can further include a display 30 on the body 18 for selective display of information received from a remote computer across a network, such as remote processing 22 or data store 21.

The remote processing 22 can further communicate analyzed data to the computer platform 20 of the Raman spectrometer device 16 and can further pull and send data to the data store 21 and process data either substantially in real-time or in a delayed manner. The spectrometer 24 can use an orbital raster scan mode to probe the fluid sample 12. The spectrometer 24 can further include a display 30 for selective display of information received from the remote processing 22, such as analysis data for the fluid sample 12.

The specificity of body fluid trace detection at a crime scene can be affected by an underlying surface (substrate 14) such as floor tile, paper tissue, or contaminants, which can contribute to Raman scattering. The substrate's surface energy, the interaction between the body fluid and substrate, determines the wetting and affects the final morphology of the dried biofilm. A substrate 14 can produce Raman scattering that is stronger by orders of magnitude compared to a body fluid signal. To implement Raman spectroscopy in practical forensics, the interference signal from common substrates must be overcome. A popular experimental approach to avoid substrate interference is restoring an initial state of body fluid by a sample soluting in water. However, this is time-consuming and destructive because adding water to dried body fluid, accompanied by chemical reactions, can affect Raman spectra. Therefore, the vital problem of body fluid trace identification is the interference from a substrate 14. This problem can be solved in two ways: considering a substrate as an additional component in a combination of “sample & substrate” or extracting Raman spectra of a target body fluid sample 12 from this combination without defining substrate 14 characteristics.

The former can be realized through methods similar to a multivariate curve resolution based on a bilinear model of a complex mixture spectrum in the form of a superposition of contributions of pure components. In common, the problem is described by an equation set:

$$W = {CS}^{t}$$

where is the S matrix of all component spectra in a composition, C is the matrix of concentrations, and Wis the matrix of experimental spectra.

Here, superscript character t means matrix transposition. One of the main issues here is to have standard Raman spectra of a body fluid and a substrate separately. The latter can be solved easily using consequent measurements. The only way to acquire the standard spectrum of a body fluid is to measure it using a minimally interacting substrate 14. Past studies have compared Raman scattering from blood samples deposited on various substrates, including borosilicate glass, a silicon wafer, a polyethylene cup, and a microscope slide coated with commercial aluminum foil. Raman scattering peaks from all substrates, except aluminum foil, were detected. Therefore, the Al substrate is the most suitable for recording standard Raman spectra of targeted substances. This approach was applied to differentiate multicomponent Raman spectra and exclude interference from substrate contributions. Others successfully used alternating least squares statistics and multivariate curve resolution to decode blood signatures in the experimental Raman spectra of biological samples in the presence of contaminants. Others used partial least squares discriminant analysis to distinguish the age of blood samples with high accuracy in the presence of polymer substrate interference. They used a rather strong assumption that the polymer is homogeneous and produces the same contribution to all spectra.

The identification of a target body fluid on an interfering substrate without defining its characteristics (knowledge S of is not complete) is more attractive. In this situation, the above can be solved for the case when we have experimental spectra for the compositions with varied concentrations of some components in a mixture during its evolution, for example, associated with a chemical process (Manne condition in a concentration space, see FIG. 2.) A Manne condition means that concentrations of two components in a mixture can be identified if intervals of evolution variable corresponding to their function f(t) nonzero values (the function carrier shown as a rectangle in FIG. 2) do not overlap. In fact, this condition means that the concentration of a specific component can be restored if, during this mixture evolution, there is a situation when the concentration of the remaining components is zero. The latter is hardly implemented for the interfering substrate because it means that we should have a spatial point where substrate impact is absent. Of course, the opposite task of substrate characteristic identification can be easily solved by measuring at a spatial point on the substrate surface where a biofluid stain is absent. A weaker version of this condition can be fulfilled for a target component by combining multivariate curve resolution with the addition method (MCRAD). The latter can be implemented by varying the concentration of a target component by chemical manipulations or virtually (by computer simulations). The benefit of the MCRAD is that only the target component concentration has to be varied.

Therefore, we do not need any information or special conditions for the interfering substrate.

FIG. 2 is a graph 60 of Manne condition in a concentration space. Here, f(t) is the concentration of one component (solid line) and another component (dotted line). The function carriers are shown as rectangles. According to the Manne condition, the function carriers should not completely overlap. Here, the dark star corresponds to the area of evolutionary variable, where the solid component can be analyzed without the influence of the dotted component. The opposite situation is marked with a light star.

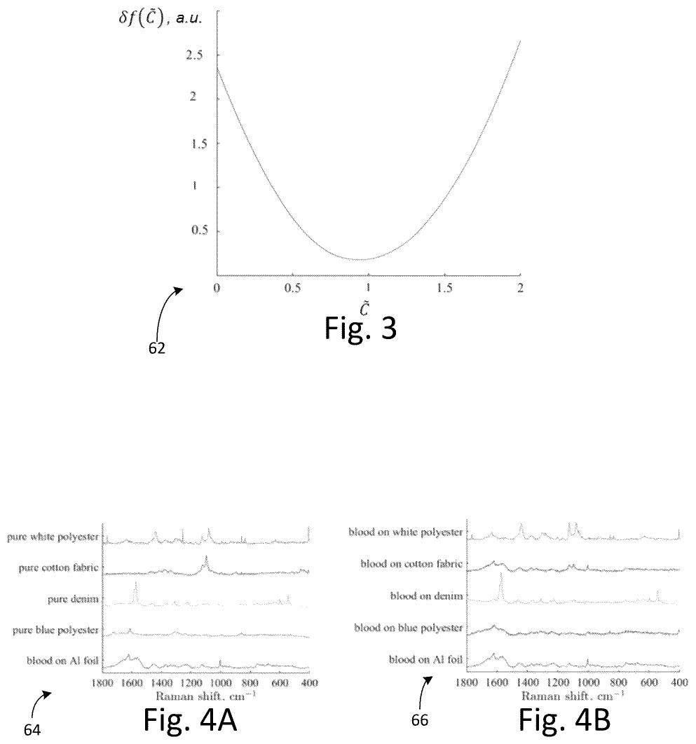

Another approach to extract a certain component concentration from an IR absorption spectrum of a complex gas mixture was developed by us 40,41. The approach starts from degenerating Eq. (1) in the following form:

$${S}_{org} ( k ) = {S}_{blank} ( k ) + C \cdot {S}_{ref} ( k )$$

where S_{org} is an experimental spectrum, S_{ref} (k) is a spectrum of a target component, C is its concentration (or any other quantitative characteristic of this component volume fraction), which is a priori unknown, and S_{blank} is an unknown spectrum of other components in a mixture. k is a wavenumber (Raman shift). This approach uses the concentration restoration criterion for a specific component based on reducing the spectrum complexity (RSC) when the spectral component is removed from the experimental spectrum (see FIG. 3). FIG. 3 is a graph 62 of the functional dependence on variable parameter Ĉ. Here, the true concentration value C is equal to 1.

This criterion is associated with the minimization of the following functional:

$$δ f ( \tilde{C} ) = \int \vert \frac{d ( {S}_{org} - \tilde{C} \cdot {S}_{ref} )}{dk} \vert dk .$$

Here, one needs to know the spectrum of the target component, and the latter has to have spectral peculiarities relative to other components. The latter is the same Manne condition but in a spectral space, which resembles the condition of applicability of DIAL (differential absorption LIDAR) or DOAS (differential optical absorption spectroscopy) approaches to study the molecular composition of the atmosphere using multifrequency absorption data. The MCRAD and RSC implement a “one-per-step” decomposition approach, which is more suitable for practical use. It should be noted that some variation of MCRAD has previously been used for recovering a known Raman spectral component from a complex matrix, while RSC is not known to have been used yet for this purpose.

The inventors have tested the capability, limitations, and benefits of the “one-per-step” decomposition model for the detection and correct identification of blood traces on interfering substrates using Raman spectroscopy. We applied MCRAD and RSC to Raman spectral data obtained for bloodstains on various common substrates, pure bloodstains, and pure substrates. The RSC method detected blood with a confidence probability close to 100%. The MCRAD method was shown to demonstrate a poor ability to detect bloodstains on blue polyester, denim, white polyester, and cotton fabric. The control studies aimed at apparent blood detection on pure substrates. Both methods demonstrated a good but not perfect ability to prove that bloodstains are absent on pure substrates. It is believed that false positive errors are associated with a similarity between blood and substrate Raman spectra. This is illustrated using the Soergel distance between Raman spectra of blood and a substrate.

To simulate realistic bloodstain evidence, which is typically recovered at the scene of a crime, droplets of whole blood of 10-μL volume were deposited on the surface of white cotton fabric, white polyester fabric, blue polyester fabric, and denim fabric using a micropipette. The bloodstains were left to dry overnight under ambient conditions. A bloodstain on aluminum foil was used as a standard sample on a noninterfering substrate. Automatic mapping was used to collect multiple Raman spectra from different spots of the sample to probe potential sample heterogeneity. Selected Raman spectra of bloodstains on various substrates as well as Raman spectra of the substrates are shown in FIGS. 4A-4B.

FIG. 4A is a graph 64 of selected Raman spectra of pure blue polyester, denim, cotton fabric, and white polyester substrates. FIG. 4B is a graph 66 of the bloodstains on Al foil on the same pure substrates as FIG. 4A. The Raman spectrum of blood on Al foil is consistent with the pure blood spectra reported previously. Spectra of bloodstains on various substrates show a significant contribution from substrates. The Raman spectrum of a bloodstain on denim is dominated by denim, which further illustrates the need for special data analytics to detect blood traces on such interfering substrates.

The origin of specific blood Raman peaks is as follows. The pronounced peak at 1658 cm⁻¹ corresponds to the amide I vibrations in a peptide chain. The peak at 1003 cm⁻¹ and a doublet at 826 and 856 cm⁻¹ corresponds to phenylalanine and tyrosine. The band at 754 cm⁻¹ is associated with the pyrrole ring. The carbohydrates provide Raman peaks near 960, 1032, 1127 and 1208 cm⁻¹ related to the stretching of C—O, C—C, C—O—H and C—O—C bonds. Peaks detected at 1449 and near 1340 cm⁻¹ can be associated with lipoproteins but their content has individual variability. The Raman bands at 623 and 644 cm⁻¹ refer to phenylalanine and tyrosine, respectively.

The denim fabric has the most intense Raman peak at 1573 cm⁻¹ which is attributed to the indigo. Raman bands from 1030 to 1150 cm⁻¹ and at 1380, 1340, 1090 and 460 cm⁻¹ correspond to cotton fibers. These bands are presented in white cotton Raman spectrum.

For blue polyester, the Raman band at 1725 cm⁻¹ corresponds to the stretching of the carbonyl group C═O, the band at 1612 cm⁻¹ corresponds to C—C vibrations in the aromatic ring. The 702 cm⁻¹ band also corresponds to the stretching of the C—C bonds in the ring. The Raman bands at 859 cm⁻¹, 998 cm⁻¹, 1096 cm⁻¹, 1179 cm⁻¹, 1291 cm⁻¹, 1416 cm⁻¹, 1463 cm⁻¹ belong to a polyethylene terephthalate. For white polyester, the Raman bands at 1637 cm⁻¹, 1440 cm⁻¹, 1080 cm⁻¹, 1280 cm⁻¹, 1300 cm⁻¹, 1128-1060 cm⁻¹, 1235 cm⁻¹ are associated with nylon stripes.

A Raman spectrum of a bloodstain on an interfering substrate is described by the above equations, where C is the volume fraction (VF) of the blood. The results of the application of MCRAD and RSC for the set of experimental Raman spectra of bloodstains on tested substrates are shown in FIGS. 4A-4B. Calculations were conducted for a full Raman spectral dataset for a bloodstain on each common substrate and noninterfering Al foil. The latter was considered the blood spectral standard. The results of blood volume fraction restoration are presented in the form of the probability density function f(C):

$$\int f ( C ) dC = 1$$

which characterizes the distribution of restored blood volume fraction values. The restored volume fractions are defined by all combinations of experimental Raman spectra of a bloodstain on a specific substrate and experimental Raman spectra of a bloodstain on an Al foil. Further data preprocessing included the calculation of a mean value and standard deviation for every value of restored volume fraction C.

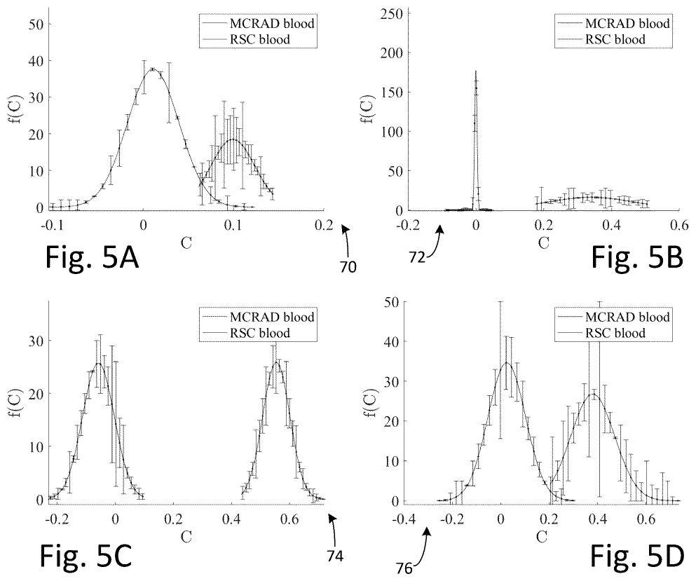

It was found that the MCRAD predicted mean values of C close to zero, while the RSC predicted a mean value of approximately 0.1 for the bloodstain on the blue polyester, 0.4 for denim and white polyester, and 0.6 for cotton fabric. Notably, these results were obtained for samples containing bloodstains on the substrates. Therefore, MCRAD gave a quantitatively incorrect result (false negative). To further validate this conclusion using a statistical approach, we evaluated the hypothesis of the absence of blood on a substrate using the standard score criterion: Z=(0−μ)/σ, where μ is the mean value in a dataset and σ is the standard deviation. Here, the Z score shows how far the mean value of an experimental random parameter is from zero on a scale of the standard deviation. In other words, the larger |(0−μp)|/σ is, the more confidently we can say that the estimated parameter is different from zero. The results of the Z score calculations and the confidence probability P of the blood absence in the sample are shown in Table 1 for each of the distributions f(C) which are presented in FIGS. 5A-5D.

TABLE 1

| | Blood on a | Blood on a | Blood on a | Blood on a |
|---|---|---|---|---|
| | blue polyester | denim fabric | cotton fabric | white polyester |
| | Z score | | | |
| MCRAD | −0.0002 | 0.03 | 1.7 | 0.54 |
| RSC | 2.8 | 2.2 | 6.6 | 2.7 |
| | P | | | |
| MCRAD | 0.999 | 0.976 | 0.093 | 0.59 |
| RSC | 0.006 | 0.031 | <0.0001 | 0.007 |

If we choose the confidence level of 95%, it will correspond to the interval from −1.96 to 1.96 in Table 1. The confidence probabilities of blood absence in a sample calculated according to Z scores are presented in Table 1.

FIG. 5A is a graph 70 of the blood volume fraction restored by MCRAD and RSC in experimental Raman spectra of bloodstains on a blue polyester substrate. FIG. 5B is a graph 72 of the blood volume fraction restored by MCRAD and RSC in experimental Raman spectra of bloodstains on a denim substrate. FIG. 5C is a graph 74 of the blood volume fraction restored by MCRAD and RSC in experimental Raman spectra of bloodstains on a cotton fabric substrate. FIG. 5D is a graph 76 of the blood volume fraction restored by MCRAD and RSC in experimental Raman spectra of bloodstains on a polyester substrate. These distributions were calculated using the MCRAD and RSC methods for all combinations of every Raman spectrum of a bloodstain on an Al foil with every Raman spectrum of a bloodstain on a corresponding substrate. After that, the mean value and standard deviation were calculated.

Therefore, the MCRAD method with a confidence probability of not less than 95% demonstrates the absence of blood for the bloodstains on blue polyester and denim. The same predictions are fulfilled for white polyester with a confidence probability of 59%. The MCRAD predicts blood presence on a cotton fabric with a confidence probability of 91%. The RSC method demonstrates the presence of blood for the same samples with a confidence probability close to 100%.

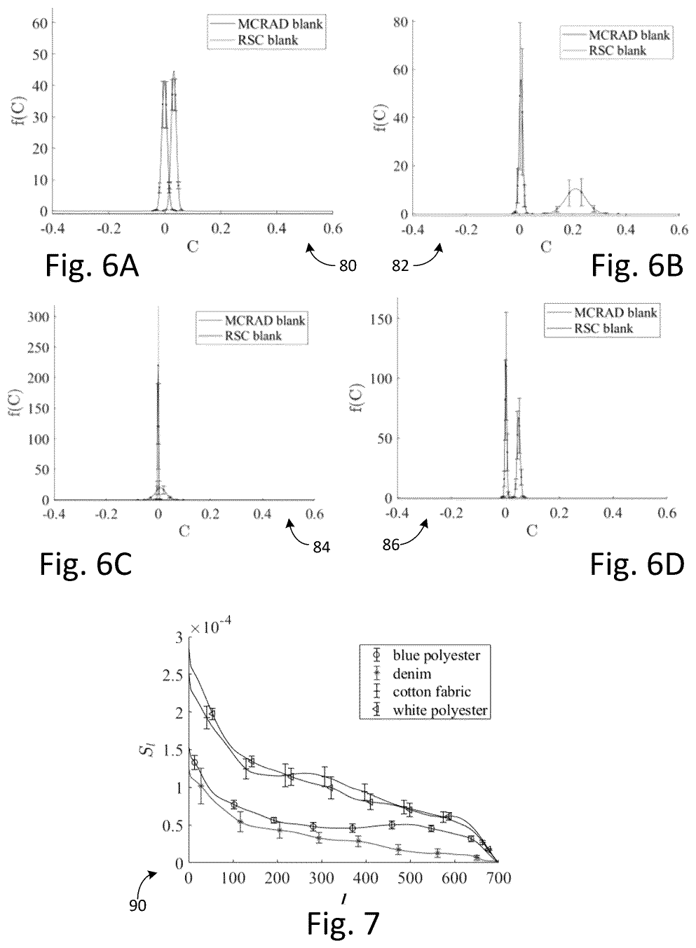

It is of great importance to determine the potential for false positives. The results of an attempt to detect blood on pure substrates using MCRAD and RSC are shown in FIGS. 6A-6D. FIG. 6A is a graph 80 of the blood volume fraction restored by MCRAD and RSC in experimental Raman spectra of bloodstains on a blue polyester pure substrate.

FIG. 6B is a graph 82 of the blood volume fraction restored by MCRAD and RSC in experimental Raman spectra of bloodstains on a denim pure substrate. FIG. 6C is a graph 84 of the blood volume fraction restored by MCRAD and RSC in experimental Raman spectra of bloodstains on a cotton fabric pure substrate. FIG. 6D is a graph 86 of the blood volume fraction restored by MCRAD and RSC in experimental Raman spectra of bloodstains on a polyester pure substrate.

The blood volume fractions were estimated as follows. We used the MCRAD and RSC methods for all combinations of every Raman spectrum of a blood sample on an Al foil with the Raman spectrum of a sample of corresponding pure substrate. In total, RSC demonstrates an appropriate level of such error for more substrates compared to MCRAD. The issue is a denim substrate. Therefore, taking into account the results presented in FIGS. 5A-5D and 6A-6D, RSC appears to be a more universal method in a case when we do not have a priori information about whether there is a biological sample on a substrate and which one.

It is believed that the bias in extracting a blood volume fraction from a pure substrate (see, for example, FIG. 5B) is associated with a similarity between blood and the substrate Raman spectra. To test this hypothesis, we used the Soergel distance to quantitatively estimate the similarity of two spectral curves:

$$S = \frac{{\sum }_{i = 1}^{N} \vert {x}_{i} - {z}_{i} \vert}{{\sum }_{i = 1}^{N} max ( {x}_{i} , {z}_{i} )}$$

where xᵢ and zᵢ are these curve abscissa values (Raman signal) for the same ordinate (Raman frequency shift). Nis the number of data points in the curves. Let us denote Sᵢ as the value of S calculated according to the above equation but for two spectra, which are preliminary averaged over a sliding spectral window including I points (I<N).

In other words, this means that Raman spectra are averaged in the sequential intervals including I spectral points. Here, we used spectral preliminary normalization based on the area under a spectrum curve. In this case, for I→N, lim Sᵢ=0. Note that Sᵢ=0 for identical curves for any I. Therefore, Sᵢ(I) may provide information about the similarity of the two spectra. The results of the Sᵢ calculation for a blood spectrum on an Al foil and a common substrate are presented in FIG. 7.

FIG. 7 is a graph 90 of the calculated dependence of the Soergel distance Sᵢ on the number of points in the sliding spectral window for bloodstain spectra on Al foil and common substrates. Calculations were conducted for mean Raman spectra of blood on an Al foil and spatially averaged Raman spectra of a specific substrate. To calculate Sᵢ(I) we initially averaged Raman spectra for spectral subintervals with length I. Then, we calculated Sᵢ(I) for all combinations of every Raman spectrum of a blood sample on an Al foil with every Raman spectrum of a blood sample on a corresponding substrate. After that, the mean value and standard deviation were calculated. This procedure was repeated for I varied in the interval [1,N]

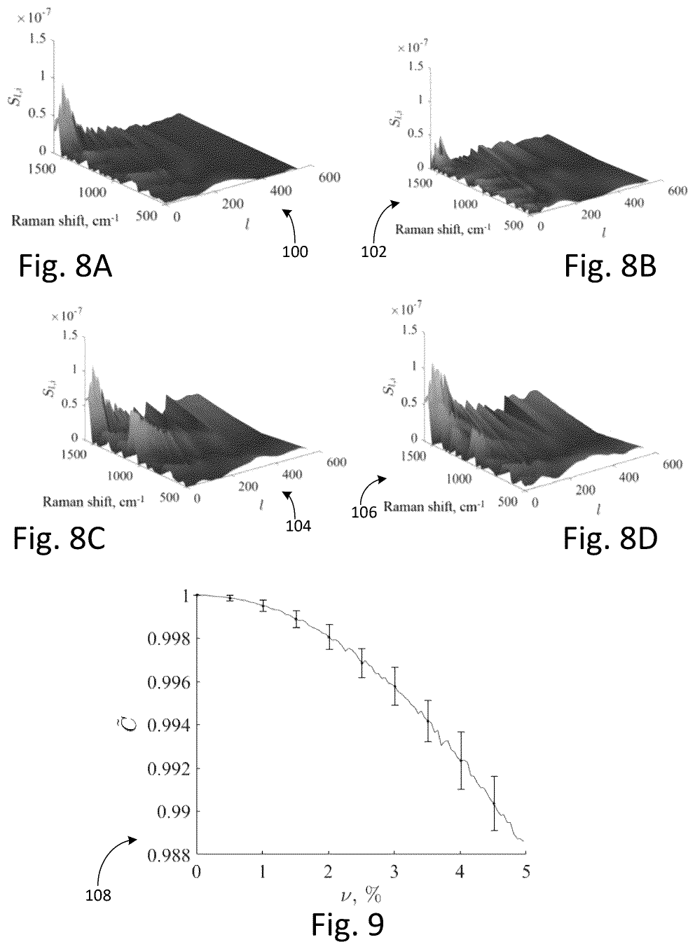

We see that the dependence on SI on I for denim substrate has smaller values compared to other substrates, especially for I>400. This substrate gives the largest errors in the estimation of a blood volume fraction on the pure substrates using the RSC (see FIG. 6B). In more detail, the Soergel distances calculated for individual sliding spectral windows for various Raman frequency shifts are presented in FIGS. 8A-8D.

FIGS. 8A-8D are graphs of the results of the Soergel distance calculations in an individual sliding spectral window for various Raman bands with the distance is presented in terms of mean values between the Raman spectra of blood on Al foil and a pure blue polyester substrate (FIG. 8A, graph 100); a denim substrate (FIG. 8B, graph 102); a cotton fabric substrate (FIG. 8C, graph 104); and a white polyester substrate (FIG. 8D, graph 106). These calculations were conducted in the same manner as the results presented in FIG. 7. We see that the difference between blood and denim Raman spectra is minimal compared to other substrates. This can be a reason for the largest error in the results presented in FIGS. 6A-6D. Therefore, metrics such as the Soergel distance can estimate the spectral peculiarities of comparing spectra.

In general, the accuracy of any analytical method of a mixture decomposition using Raman spectroscopy data is defined by; (i) a similarity of Raman spectra of pure components existing in a studied composition; (ii) the ration of the pure components volume fractions. The detection of a target component is complicated essentially in the case of its strong similarity and small volume fraction relatively other components in the studied composition.

The RSC method is based on subtracting a target Raman spectrum with an unknown weight coefficient C from an experimental spectrum of a complex sample, achieving a minimum of the objective function (3). The possible reason for the greater stability and robustness of the RSC is as follows. RSC is based on the application of the L1 norm to a function:

$$\vert \frac{d ( {S}_{org} - C \cdot {S}_{ref} )}{dk} \vert$$

through an estimation of an integral as referenced above. The L1 norm is associated with function integration over an independent variable variation interval. Let us explicitly include random noise in the description. Both S_{org} and S_{ref} can include an additive random noise (Rᵢ(k), R₂(k)):

$${S}_{org} ( k ) = {S}_{org}^{0} ( k ) + {R}_{1} ( k )$$

$${S}_{ref} ( k ) = {S}_{ref}^{0} ( k ) + {R}_{2} ( k )$$

Wherein S⁰_{org}, S⁰ᵣₑₗ are the corresponding features without noise. The, the full equation takes the form:

$$δ f ( \tilde{C} ) = \int \vert \frac{d ( {S}_{blank} + {S}_{ref}^{0} ( C - \tilde{C} ) + {R}_{1} - \tilde{C} {R}_{2} )}{dk} \vert dk$$

Let R₁(k), R₂(k) be stationary random functions with zero mean values:

$${R}_{1} ( k ) = v \cdot rand ( k ) ,$$

$${R}_{2} ( k ) = v \cdot rand ( k )$$

where v is the amplitude of the noise component presented in a relative fraction of a mean value of the set of Raman spectra of blood on an Al foil, and Rand(k) is a set of random values varied in the interval [−0.5, 0.5].

If the function:

$$\vert \frac{d ( {S}_{blank} + {S}_{ref}^{0} ( C - \tilde{C} ) + {R}_{1} - \tilde{C} {R}_{2} )}{dk} \vert$$

is an ergodic random process, then integrating this function over evolution variable k is equivalent to averaging over an ensemble of realizations. The latter causes noise reduction and influences the target component concentration (volume fraction) restoration results. To obtain arguments about this, we conducted numerical experiments with the above equations, limited by a noise level up to 5% of the mean value of the Raman spectra set used, which exceeds the typical values of the noise component with a margin.

We synthesized a set of 100 realizations of random functions R₁(k), R₂(k) with v varied in the interval [0.0, 0.05] and restored volume fraction C using certain criterion. The calculation of the latter was conducted as follows. We took every Raman spectrum of a blood sample on an Al foil as a reference and used it to restore the volume fraction in the remaining Raman spectra of a blood sample on an Al foil. This procedure was repeated for all other Raman spectra of a blood sample on an Al foil. Then, the mean value and standard deviation were calculated. The results are presented in FIG. 9.

FIG. 9 is a graph 108 of the dependence of the target component (blood) volume fraction restoration error on the additive noise amplitude. Here, the true volume fraction value is equal to 1.0. One can see that the presence of such noise levels causes the target component (blood) volume fraction restoration relative error δC up to 1%. Here, δC=|C−Ĉ|/C. Therefore, RSC is quite robust to random fluctuations of spectral data due to random experimental errors and intergroup variability.

A potential reason for the weak stability and robustness of MCRAD is as follows. MCRAD is based on the above solution, with the matrix of concentrations C containing a set of Ĉⱼ+Č values, where Č is the unknown concentration (volume fraction) of a blood sample and are known additional volume fractions (VFs) according to the principle of standard addition. The evaluation of Č is conducted through an iterative solution of the set of equations:

$$\hat{{S}_{j}} = {S}_{org} + ( {\hat{C}}_{j} + \tilde{C} ) {S}_{ref} .$$

The iterative procedure is based on the application of the L2 norm (the Euclidian norm) to a function similar to (W−CS^{t}), where S is the matrix of all component spectra in a composition, Cis the matrix of concentrations, and Wis the matrix of experimental spectra. Even in the case of a spectrum with additional random noise being an ergodic random process, the L2 norm cannot be averaged over an ensemble.

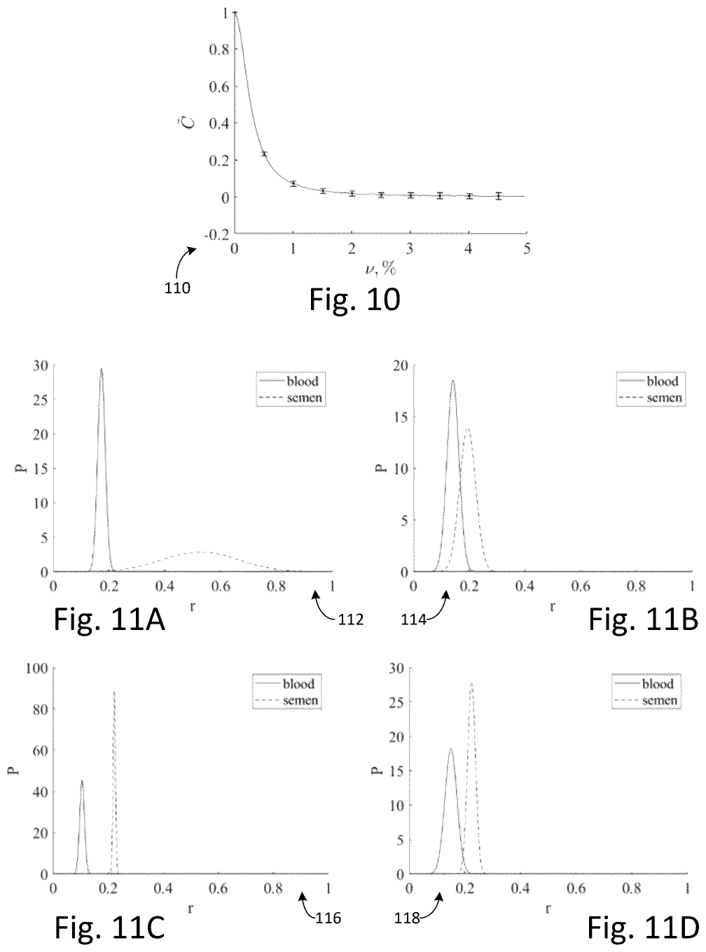

We conducted the simulation using MCRAD with the same noise model and the same noise level as for the RSC. A Raman spectrum of a bloodstain on Al foil was used as a reference to restore the volume fraction in the rest of the Raman spectra of a blood sample on Al foil. This procedure was repeated for all other Raman spectra of blood on Al foil. After that, the mean value and standard deviation were calculated. The results of the concentration (volume fraction) C restoration in 100 simulations are shown in FIG. 10.

FIG. 10 is a graph 110 of the dependence of the target component (blood) volume fraction restoration error on the additive noise amplitude. We see that the influence of noise on the concentration restoration accuracy is much stronger than that of the RSC. A possible reason is that the Euclidian norm does not allow the use of the benefits of ergodic random processes from the point of view of noise reduction. This can be a reason for the responsiveness of the MCRAD algorithm to random noise.

Potential errors (false positives and false negatives) should be accounted for. False negatives due to the low detection limit could result in missing valuable evidence. False positives could result in a significant waste of time and resources. To further reduce potential false positives for the method developed here, a second stage of the data analysis could be conducted as a part of a hierarchical approach. It is noteworthy here that running an additional analysis will not noticeably increase the total test time because of the fast spectral measurements and high speed/efficiency of modern computers. The second data analysis is the comparison of the obtained Raman spectra with the spectra of the corresponding pure substrate. The latter could be integrated into the spectral library of the software. If not, the mapping of the pure substrate could be conducted quickly at the crime scene or in the lab if the evidence sample on a piece of material is already collected and delivered to the lab.

Of course, Raman spectrum of an analyzed real biofluid sample is not exactly the same compared to an etalon Raman spectrum and it is a source of bias. However, the variations in Raman spectra of all main body fluids does not prevent 100% accuracy in their identification when a high-quality Raman spectrum was measured for a “new” sample, which was not used for the training dataset. In addition, blood is by far the most consistent body fluid (relative to other main body fluids including semen) from the viewpoint of biochemical composition. Therefore, one can use a single reference Raman spectrum of dry blood in this study in contrast to a set of individual spectral components as we have done for semen traces in our earlier work. A reference Raman spectrum using several bloodstains on an aluminum substrate and then used this reference spectrum for the detection and identification of blood traces on interfering substrates. It is very important to emphasize here that the integrated bloodstains on interfering substrates were prepared from blood samples, which were not used for developing the reference Raman spectrum of dry blood (different donors).

In any case, if there are doubts about the adequacy of the available reference spectrum of biological fluid to the sample under study, the RSC can be used in the reverse manner. One can measure the Raman spectrum of substrate in a spatial point without stain. After that, one can extract this component from the Raman spectrum measured in a spatial point with presence of a “biofluid stain & substrate” combination. The residue is a Raman spectrum of a specific biofluid stain sample. The latter can be identified by any suitable manner, for example, by comparing it with a library of biofluids' Raman spectra. The decision about what biodluid is presented can be based, for example, on a fuzzy logic approach by comparing “distances' of the residue with “standard” Raman spectra of various biofluids from the library. The implementation of this approach is shown in FIGS. 11A-11D.

FIG. 11A-11D are graphs of the probability density distribution of the proximity factor for the residuals between the experimental Raman spectra of blood stain on a definite substrate and the Raman spectra of the same pure substrate in relation to the set of Raman spectra of blood and the set the seminal fluid Raman spectra of on an Al foil. FIG. 11A is a graph 112 for a blue polyester substrate. FIG. 11B is a graph 114 for a denim substrate. FIG. 11C is a graph 116 for a cotton fabric substrate. FIG. 11D is a graph 118 for a white polyester substrate.

Here, the residuals S_{R} between the experimental Raman spectra of bloodstain on a definite substrate and the Raman spectra of the same pure substrate are compared with the set S₀ of 100 Raman spectra of blood on Al foil and 100 Raman spectra of seminal fluid on an Al foil measured by us earlier. The proximity factor was calculated using formula:

$$r = \frac{1}{2} {\sum }_{i} \frac{\vert {S}_{R , i} - {S}_{0 , i} \vert}{\vert {S}_{R , i} + {S}_{0 , i} \vert}$$

where summation is conducted over all spectral points in the compared Raman spectra. For all cases, one can conclude that residual Raman spectrum corresponds to blood. Therefore, one can conclude that there are principal solutions of the issue about, strictly speaking, absence of absolute etalon Raman spectrum of a biofluid, which perfectly corresponds to a concrete experimental sample of biofluid analyzed “here and now.” The fundamental background of this positive for practical usefulness conclusion is as follows. With reference again to FIG. 2, the black solid line in FIG. 2 corresponds to the spatial positions of biofluid stain presence. Then, in a spatial area marked by the light star, we can measure the Raman spectrum of the pure substrate because biofluid stain is absent. Therefore, this situation fully matches the Manne condition (see FIG. 2) when evolutionary variable describes a spatial position on a substrate 14 surface.

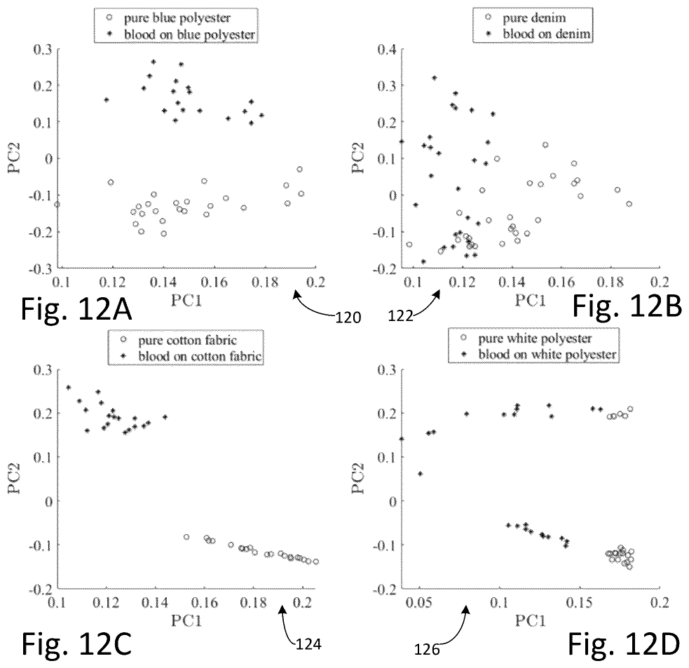

Another important issue about RSC robustness to false positive results. Once again, to validate this, one can use the Raman spectrum of substrate 14 in a spatial point without stain. One can create additional experimental data from neighboring points on a substrate surface, which do not contain blood traces (pure substrate). One can use the simplest unsupervised classification method, principal component analysis (PCA), to test whether Raman spectra from apparent bloodstains and a pure substrate could be differentiated. FIGS. 12A-12D show a PCA score plot obtained for Raman spectra collected from a bloodstain on a common substrate and those collected from the same pure substrate.

FIGS. 12A-12D show a hierarchical approach to test for potential false positives. Raman spectral data obtained for an apparent bloodstain are statistically compared with Raman spectra obtained for a pure substrate material. Principal component analysis (PCA) score plots prepared using the first and second principal components demonstrate significant separation of the two classes of Raman spectra for blood stains on all substrates used. FIG. 12A is a graph 120 of Raman spectral data obtained for an apparent bloodstain are statistically compared with Raman spectra obtained for a pure substrate of blue polyester. FIG. 12B is a graph 122 of Raman spectral data obtained for an apparent bloodstain are statistically compared with Raman spectra obtained for a pure substrate of denim. FIG. 12C is a graph 124 of Raman spectral data obtained for an apparent bloodstain are statistically compared with Raman spectra obtained for a pure substrate of cotton fabric. FIG. 12D is a graph 126 of Raman spectral data obtained for an apparent bloodstain are statistically compared with Raman spectra obtained for a pure substrate of white polyester.

These two classes of Raman spectra could be differentiated with high confidence in the case of blue and white polyester and cotton. However, there is some overlap on the score plot for Raman spectra collected from a bloodstain on denim substrate and those collected from pure denim. We believe that this is because denim has a strong Raman signal and overwhelms the signal from blood. As evident in FIGS. 4A-4B, Raman spectra of a bloodstain on denim substrate are very similar to the spectra of pure denim with no noticeable contribution from blood. Nevertheless, despite some overlap, there is a significant number of points on the score plot, which are well separated. Therefore, this approach allows for testing for false positives even in the case of denim if Raman spectra are collected from multiple points on the bloodstain and compared with those collected from a pure denim.

For purposes of testing the present invention blood samples were purchased from BiolVT, LLC (Westbury, NY), from five anonymous donors. Donors were negative for HbsAg, HCV, HIV-1 &2, syphilis, and HIV-1 antigen. All samples were deposited onto one of the following substrates: aluminum tape, white cotton fabric, white polyester fabric, blue polyester fabric, and denim fabric, pipetting 10 μL on the surface and letting it dry overnight.

A Renishaw InVia confocal Raman spectrograph equipped with a research-grade Leica microscope, a long-range 50× objective, and a Renishaw PRIOR stage for automatic mapping were used to collect the Raman spectra over a range of 400-1800 cm⁻¹. A 785-nm laser light was utilized for excitation. The maximal laser power was about 80 mW. It was reduced from to ten percent capacity with a spectrum accumulation time of 10 s to avoid photodegradation. The spot size of the excitation beam on the sample was approximately 2 μm using standard confocal mode and a 50-μm slit. Multiple spectra were collected from different spots of each bloodstain using automatic mapping, and each spectrum was an average of ten accumulations. Peak accuracy was assured by verifying instrument calibration before each analysis using a silicon standard. All spectrum measurements were first treated using WiRE 3.4 software to remove any cosmic ray interference. The processing of the received data was performed with MATLAB software. Outliers were removed using the random forest method. The preprocessing of the experimental Raman spectra was conducted in 3 steps: background subtraction (a standard procedure for minimizing the fluorescence contribution), a random noise filtration, and normalization by the area under the curve. The background subtraction was implemented by shape-preserving piecewise cubic interpolation of a Raman spectrum at neighboring grid points in a gliding spectral window with a width of 200 spectral points (182.2 cm⁻¹), the quantile value is set to 10%. The noise reduction was implemented using Savitsky-Goley filter with the following parameters' value: the order of the polynomial was equal to 1, the gliding spectral window width was equal to 45 spectral points (41 cm⁻¹). Finding this filter optimal parameters was estimated by the following way. The random nature of noise allows us to consider the average Raman spectrum Ŝₛₐₘₚ of an experimental sample set of S_{samp,i} spectra:

$${\overline{S}}_{samp} = \frac{1}{N} {\sum }_{i = 1}^{N} {S}_{samp , i}$$

as an approximation to the actual spectrum without noise. Here, N is the volume of the experimental set. Let's denote the Raman spectrum S_{samp,i}(k) processed by Savitsky-Goley filter as S_{SG,j} (k) where k=1,K is Raman shift. Optimal filter parameters are corresponded to minimum of the following functional r:

$$r = \frac{1}{2 NK} {\sum }_{j , k} \frac{\vert {S}_{SG , j} ( k ) - {\overline{S}}_{samp} ( k ) \vert}{\vert {S}_{SG , j} ( k ) + {\overline{S}}_{samp} ( k ) \vert}$$

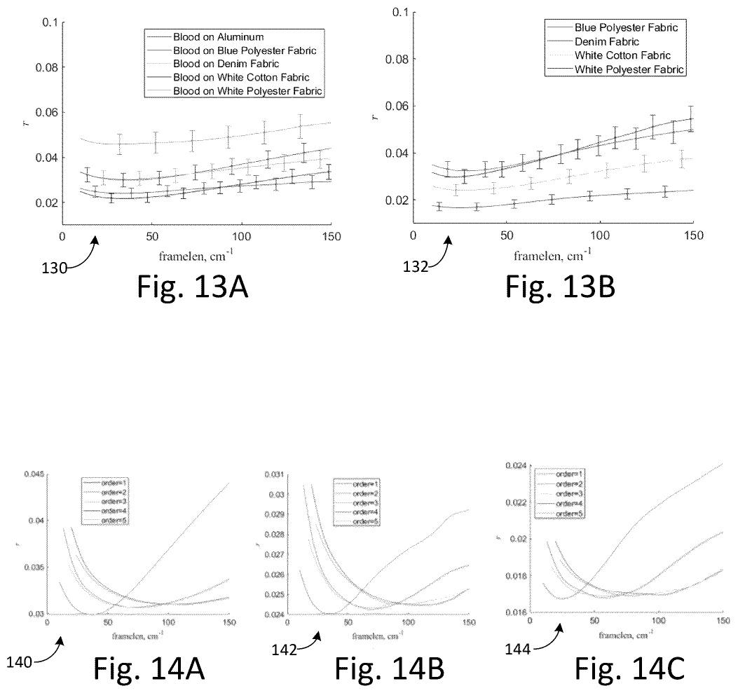

The dependence of r on the gliding spectral window width is presented in FIGS. 13A-13B. FIG. 13A is a graph 130 of the dependence of r on the gliding spectral window for Raman spectra of blood on various substrates processing by a Savitsky-Goley filter. FIG. 13B is a graph 132 of the dependence of r on the gliding spectral window for Raman spectra of pure substrates processing by a Savitsky-Goley filter. Here, the first-order polynomial was used in this filter implementation. Here, “framelen” parameter means the gliding spectral window. Also, we used the first-order polynomial in Savitsky-Goley filter. In common, the choice of the gliding window width about 40 cm⁻¹ is quite reasonable. The using polynomial of more high orders reduces the quality of filtration because less value corresponds more close shape of a processed by Savitsky-Goley filter Raman spectrum to an average Raman spectrum of the respective experimental sample set.

FIG. 14A is a graph 140 of the dependence of on the polynomial order for Raman spectra of blood on Al substrate and a blue polyester substrate. FIG. 14B is a graph 142 of the dependence of on the polynomial order for Raman spectra of blood on Al substrate and a pure blue polyester substrate. FIG. 14C is a graph 144 of the dependence of on the polynomial order for Raman spectra of blood on Al substrate and processing by Savitsky-Goley filter. The typical Raman spectra signal-to-noise value near their maxima was about 62 dB, the mean value of this parameter was about 7 dB that is caused by presence of many small peaks.

With respect to the detection of semen, the two approaches based on RSC and MCRAD were used and compared to separate the spectra of semen from those of polyester and glass substrates. These two substrates exhibit a significant interference but in different ways, with polyester having a large Raman signal with many peaks throughout the spectra and glass having a very large fluorescence signal that masks most Raman signals. Regardless of the reason behind the complexity, RSC was able to separate the semen signal from the substrate signal in a joint Raman spectrum without using a reference Raman spectrum of the substrate.

The peculiarity of both RSC and MCRAD is that they need to know a reference Raman spectrum of a studied fluid sample. The difference between the reference and experimental Raman spectra caused by person-to-person chemical variability of biofluids and external conditions is a source of possible inaccuracy of these methods. One of the ways to overcome this limitation is to use a decomposition of a biofluid Raman spectrum on principal chemical substances or abstract features like principal components.

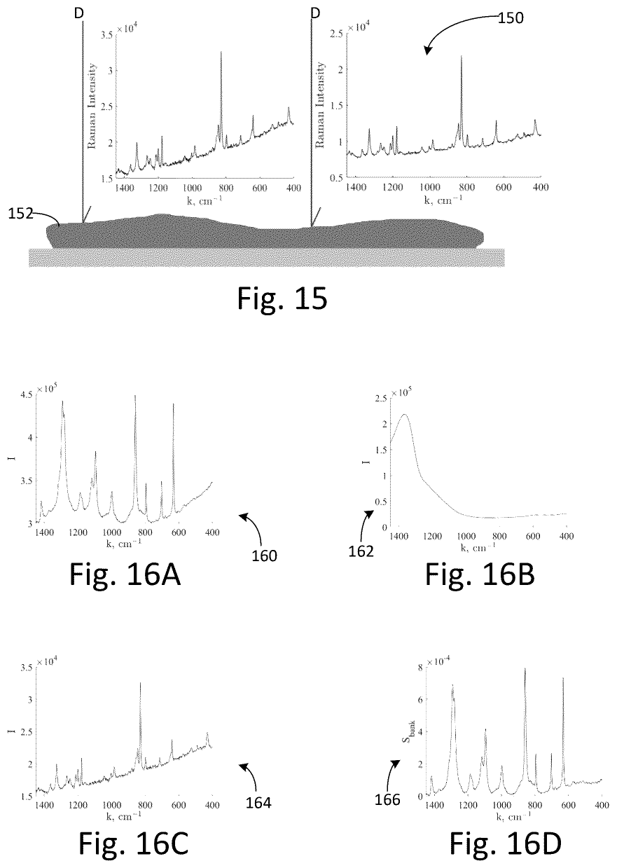

FIG. 15 is a representative diagram of the typical Raman spectra shift of a semen stain on an Al foil substrate 152 with illustrative graphs of the Raman intensity. The graphs 150 illustrate the Raman intensity, shown by arrows D, demonstrating the Raman shift.

Semen samples were collected from anonymous donors at an in-vitro fertilization clinic after a laboratory analysis. A small 10 μL drop of semen fluid was placed on a substrate and dried under room conditions. A Renishaw inVia confocal Raman spectrometer equipped with a research-grade Leica microscope, 20 long-range lens (numerical aperture of 0.35), and WiRE 2.0 software was used. A 785-nm laser light was utilized for excitation. The laser power on the dried samples was about 115 mW, and the spot size of the excitation beam in standard confocal mode was about 5 mm wide. The spectral resolution was about 3.5 cm−1, and peak accuracy was assured by calibration with a silicon standard. For the automatic mapping, the lower plate of a Nanonics AFM MultiView 1000 system was set up under the microscope, and measurements were taken using Quartz II and QuartzSpec software. The used Raman spectra data set is presented in Table 2. The processing of the received data was carried out with MATLAB software.

TABLE 2
The used Raman spectra dataset

| Sample | Number of Raman spectra |
|---|---|
| Blue polyester substrate | 30 |
| Semen on blue polyester substrate | 70 |
| Glass substrate | 9 |
| Semen on glass substrate | 35 |
| A semen sample on Al foil | 824 |

The Raman spectra of semen samples were recorded at several spatial points on every substrate sample. The points were taken in a 0.5 mm×0.5 mm square area of the sample. The step distance between the points was 4-5 μm. The outliers removal had been conducted using the random forests method 30. The number of Raman spectra remaining after this procedure is shown in Table 2. A relatively large number of Raman spectra of a semen sample on Al foil used in the analysis compared with other samples allowed for obtaining the most accurate spectroscopic signature of pure semen.

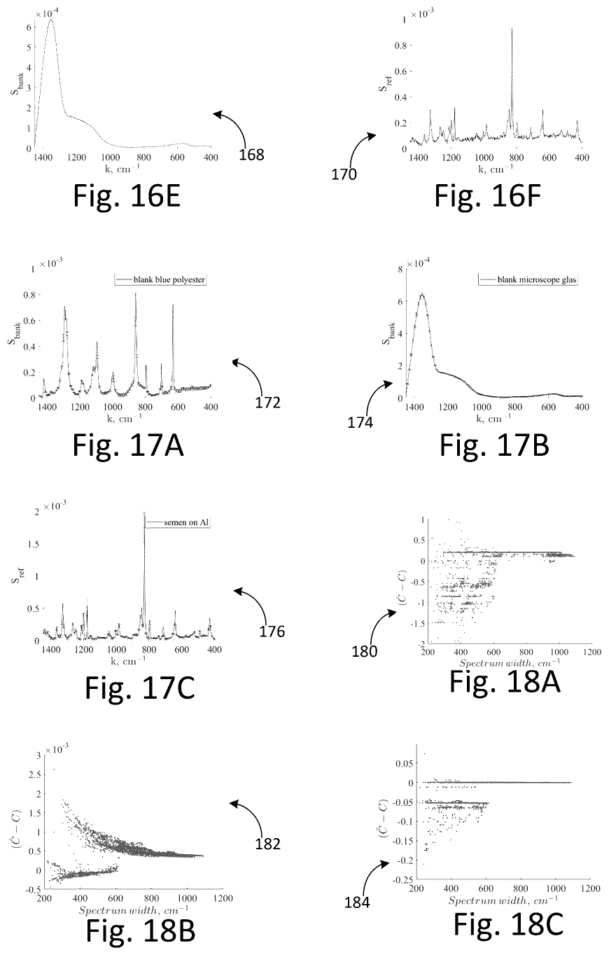

The background subtraction was implemented by shape-preserving piecewise cubic interpolation of a Raman spectrum at neighboring grid points in a gliding spectral window with a width of 200 spectral points (182.2 cm⁻¹), the quantile value is set to 10%. The noise reduction was implemented using a Savitsky-Goley filter with the following parameters' value: the order of the polynomial was equal to 1, and the gliding spectral window width was equal to 45 spectral points (41 cm⁻¹). After that, the Raman spectra were averaged, and variations were evaluated. The Raman spectra of the polyester and glass substrates and the Raman spectra of seminal fluid on an aluminum substrate are shown in FIGS. 16A-16F.

FIG. 16A is a graph 160 of the spatially averaged Raman spectra of polyester before baseline correction. FIG. 16B is a graph 162 of the spatially averaged Raman spectra of glass before baseline correction. FIG. 16C is a graph 164 of the spatially averaged Raman spectra of seminal fluid on an aluminum substrate before baseline correction. FIG. 16D is a graph 166 of the spatially averaged Raman spectra of polyester of FIG. 16A after the baseline correction. FIG. 16E is a graph 168 of the spatially averaged Raman spectra of glass of FIG. 16B after baseline correction. FIG. 16F is a graph 170 of the spatially averaged Raman spectra of seminal fluid on an aluminum substrate of FIG. 16C after baseline correction.

The standard deviations are also shown FIGS. 17A-17C. FIG. 17A is a graph 172 of the spatial averaged (with standard deviation) Raman spectra of polyester after baseline correction. FIG. 17B is a graph 174 of the spatial averaged (with standard deviation) Raman spectra of glass after baseline correction. FIG. 17C is a graph 176 of the spatial averaged (with standard deviation) Raman spectra of seminal fluid on an aluminum substrate after baseline correction.

Based on Raman spectroscopy, the chemometric approach MCRAD was used to isolate and identify a biofluid stain on a strongly interfering substrate, which needs only knowledge of the reference Raman spectrum S_{ref} of the analyzed biofluid. An experimental Raman spectrum S_{org} of a biofluid stain on a substrate is given in the form:

$${S}_{org} ( k ) = {S}_{blank} ( k ) + C \cdot {S}_{ref} ( k ) ,$$

where S_{blank} is the unknown Raman spectrum of the substrate, C is the biofluid stain volume fraction (VF), k is the Raman shift.

According to the standard addition method, let us add (n−1) times an additional portion C_{add} of the Raman spectrum S_{ref} to the Raman spectrum S_{org}:

$${\hat{S}}_{j} = {S}_{org} + {\hat{C}}_{j} {S}_{ref}$$

where Ĉⱼ=C+j·C_{add}, j=0̅,̅ .̅ .̅ .̅ ,̅ (̅n̅−̅1̅)̅. Often, Raman spectra second derivative is used to improve sensitivity of spectral analysis due to eliminating the background impact and enhancing the spectra peculiarities. Then, the following matrix equation can be formulated:

$$A = ( \frac{{d}^{2} {\hat{S}}_{1}}{{dk}^{2}} , … , \frac{{d}^{2} {\hat{S}}_{j}}{{dk}^{2}} , … , \frac{{d}^{2} {\hat{S}}_{n}}{{dk}^{2}} ) ≅ WH$$

where W—matrix consisting of two parts:

$$\frac{{d}^{2} {S}_{org}}{{dk}^{2}}$$

and unknown

$$\frac{{d}^{2} {\hat{S}}_{ref}}{{dk}^{2}} ,$$

below we use

$${W}_{blank} = \frac{{d}^{2} {S}_{org}}{{dk}^{2}} .$$

The H matrix includes the n-dimensional unit vector and vector of the biofluid stain VFs Hⱼ, which are linearly dependent on Ĉⱼ. The W_{blank} and Hⱼ can be evaluated through an iteration procedure, which starts with an initial value of W as follows.

The search for the Hⱼ value is carried out with known W through minimizing a L₂ norm: ∥A−WH∥₂. The search for the W_{blank} is carried out with H calculated at previous step through minimizing a L₁ norm:

$${‖ A - WH ‖}_{2} - {c}_{{L}_{1}} ( \vert {W}_{blank} \vert + \vert \frac{{d}^{2} {\hat{S}}_{ref}}{{dk}^{2}} \vert )$$

where C_{L}_{₁}—a small parameter.

The first and second steps are repeated until the iterations converge with a definite accuracy. In the result, W_{blank} becomes equal to zero, H₁=C. Knowing C, we can find the Raman spectrum S_{blank}.

Another approach to extracting a definite component concentration from a spectrum of a complex sample was developed. This approach explores an idea of reducing spectrum complexity (RSC) when we remove entirely the target component spectrum S_{ref} multiplied on its VF C from the complex sample spectrum S_{org}²⁵. This idea can be implemented for Eq. (1) through the minimization of the following functional:

$$δ f ( \tilde{C} ) = \int \vert \frac{d ( {S}_{org} - \tilde{C} {S}_{ref} )}{dk} \vert dk$$

where \tilde{C} is the evaluation of C.

Both methods allow for solving the problem of interfering substrate, but they have different ways of solution. Their direct quantitative comparison is very useful for practical applications.

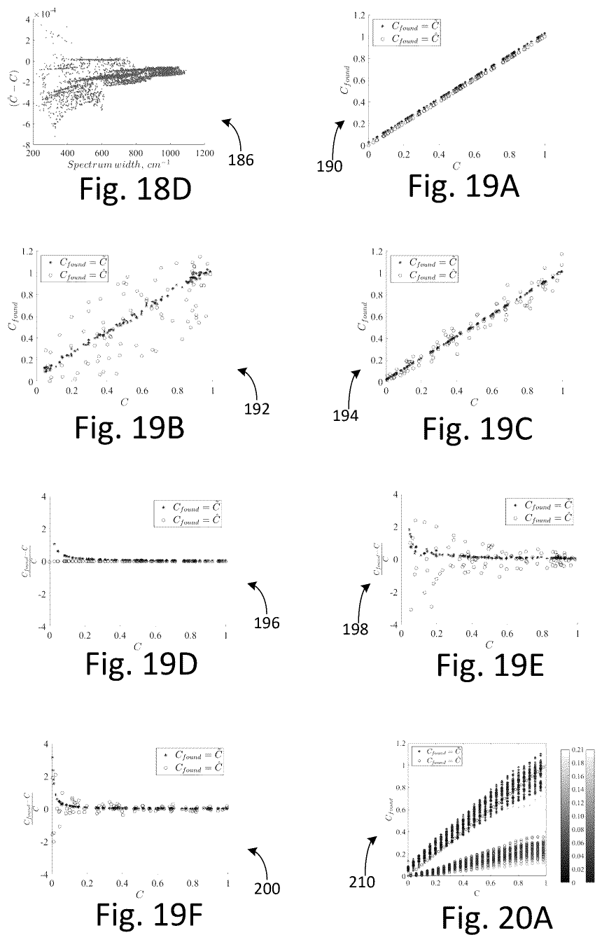

The model Raman spectra of seminal fluid on a substrate were generated according to above equations with various semen volume fractions, using data presented in Table 2. The model dataset, consisting of 100 Raman spectra, was generated 10 times, the results of analysis were averaged. The complexity of the separation of spectra of target biofluid and a substrate is defined by their similarity and used Raman scattering spectral range: more specific Raman peaks and a more extended spectral range provide more accurate separation. The residual σ between the semen real C VF and \tilde{C}═C+σ VF restored by RSC and MCRAD in dependence on the used Raman scattering spectral range was shown in FIGS. 18A-18C. These evaluations were calculated by narrower sub-bands random selecting from the measured Raman scattering range and applying RSC or MCRAD methods.

FIG. 18A is a graph 180 of the dependence of the residual σ for the RSC method for semen on a polyester substrate. FIG. 18B is a graph 182 of the dependence of the residual σ for the RSC method for semen on a glass substrate. FIG. 18C is a graph 184 of the dependence of the residual σ for the MCRAD method for semen on a polyester substrate. FIG. 18D is a graph 186 of the dependence of the residual σ for the MCRAD method for semen on a glass substrate. In general, with an increase in the Raman scattering range, the residual decreases for both methods.

To evaluate the effect of random noise, let us rewrite Eq. (1) in the form:

$${S}_{org} = {S}_{org} + ( {R}_{N} ∘ {S}_{org} ) ,$$

where (R_{N}∘S_{org})—the Hadamard product, R—a vector with the same dimension as S_{org} one, which contains random values varied inside the (−N; N) range. Here, N characterizes a random noise variation amplitude. Varying C in Eq. (1) and taking into account Eq. (6), the relation between \tilde{C} and C was estimated for various N as shown in FIGS. 19A-19F.

FIG. 19A is a graph 190 of the dependences of the C_{found}=\tilde{C} restored by the RSC (stars ‘*’) and MCRAD (blue circles) for a polyester substrate with N=0 (a). FIG. 19B is a graph 192 of the dependences of the C_{found}=\tilde{C} restored by the RSC (stars ‘*’) and MCRAD (blue circles) for a polyester substrate with N=0.01 (b). FIG. 19C is a graph 194 of the dependences of the C_{found}=\tilde{C} restored by the RSC (stars ‘*’) and MCRAD (blue circles) for a glass substrate with N=0.01 (c). FIG. 19D is a graph 196 of the relative residuals of the dependences of the C_{found}=\tilde{C} in FIG. 19A. FIG. 19E is a graph 198 of the relative residuals of the dependences of the C_{found}=\tilde{C} in FIG. 19B. FIG. 19F is a graph 200 of the relative residuals of the dependences of the C_{found}=\tilde{C} in FIG. 19C.

These results demonstrate that MCRAD works better for both small VFs and small random noise compared to the RSC. The opposite situation occurs for non-small VFs and (or) non-small random noise. The reason is that the accuracy of RSC is defined by the only difference between the target sample and the substrate Raman spectra.

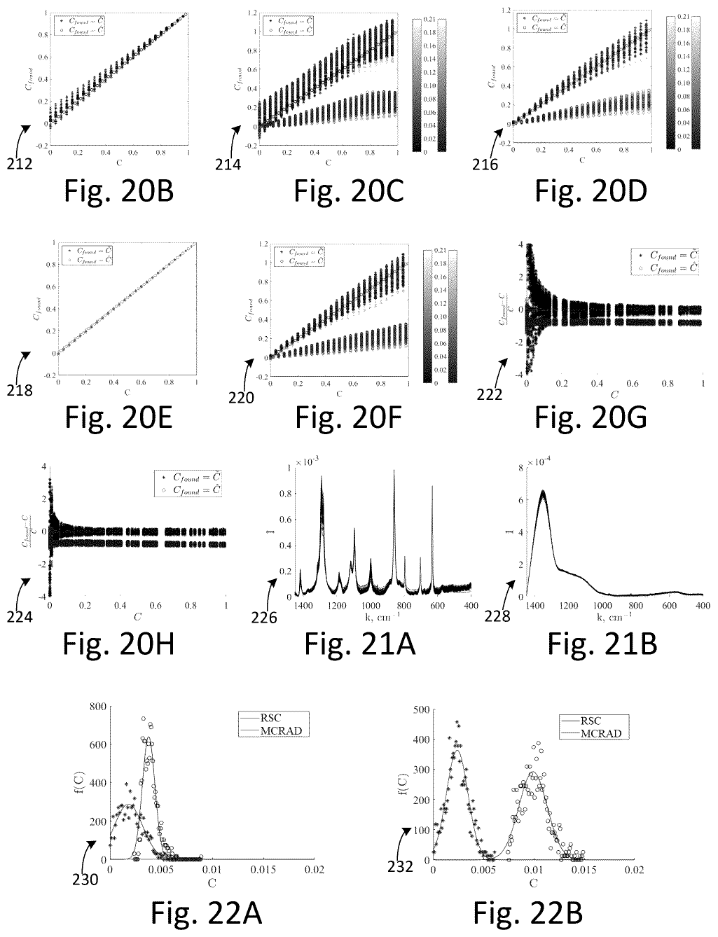

The spatial inhomogeneity of a dried biofluid drop on a substrate is a source of additional bias in the biofluid VF estimation. To estimate this factor, we applied RSC and MCRAD to evaluate \tilde{C} (C) from the Raman spectra of polyester and glass substrates and semen samples on an Al substrate measured at various spatial points. A random noise described by the above equation was preliminarily added. The estimations are presented in FIG. 20A-20H. To analyze the influence of difference between the used reference Raman spectrum of investigated biofluid and an actual sample presented in the Raman spectrum of a “biofluid stain+a substrate”, here we applied a special criterion of two curves proximity:

$$χ = \frac{\sum \vert {S}_{ref , f} - {S}_{ref} \vert}{\sum \vert {S}_{ref , f} + {S}_{ref} \vert} ,$$

where S_{ref}—the Raman spectrum of the semen stain on an Al substrate used for generation of a set of Raman spectra of the model samples of a “biofluid stain+a substrate”, S_{ref,e}—a reference Raman spectrum of semen stain on an Al substrate used for restoring this biofluid VF from a model sample of a “biofluid stain+a substrate”. The differences between the reference and actual semen sample Raman spectra cause significant errors in the C evaluated by MCRAD (FIG. 20A). Therefore, this method is sensitive to minor variations of initial data. This observation was also presented in the previous section. Oppositely, RSC demonstrates robustness regarding this factor.

FIG. 20A is a graph 210 taking into account spatial variations of the semen reference Raman spectra and using the averaged polyester substrate spectrum (S_{ref} is not varied, S_{ref,e} is varied). FIG. 20B is a graph 212 taking into account spatial variations of polyester substrate spectra and using the averaged semen spectrum (S_{ref}, S_{ref,e} are not varied, a substrate Raman spectrum is varied). FIG. 20C is a graph 214 taking into account spatial variations of both the semen reference and polyester substrate Raman spectra (S_{ref}, S_{ref,r}, and a substrate Raman spectrum are varied). FIG. 20D is a graph 216 taking into account spatial variations of the semen reference spectra and using the averaged glass substrate spectrum (S_{ref} is not varied, S_{ref,r} is varied). FIG. 20E is a graph 218 taking into account spatial variations of glass substrate spectra and using the averaged semen reference Raman spectrum (S_{ref}, S_{ref,r} are not varied, a substrate Raman spectrum is varied). FIG. 20F is a graph 220 taking into account spatial variations of both the semen reference and glass substrate Raman spectra (S_{ref}, S_{ref,r} and substrate Raman spectra are varied). FIG. 20G is a graph 222 of the relative error corresponding to FIG. 20C. FIG. 20H is a graph 224 of the relative error corresponding to FIG. 20F.

Interestingly, the variations of polyester and glass substrates Raman spectra do not affect MCRAD convergence (FIGS. 20B, 20E) but cause more essential errors of the RSC compared to MCRAD. On the other side, from the results of the joint variability of the S_{blank} and S_{ref} spectra (FIGS. 20C and 20F), it follows that the RSC method allows the recovery of the \tilde{C} with a stable spread. However, the recovery accuracy depends significantly on the value of C (FIGS. 20G and 20H). It follows from the results obtained for a full dataset of Raman spectra of both reference semen and substrate samples (FIGS. 20C and 20F). Still, the \tilde{C} restoration accuracy depends significantly on the C value (FIGS. 20G and 20H).

We applied the RSC and MCRAD methods for the analysis of experimental Raman spectra of semen dried on polyester and glass substrates as shown in FIGS. 21A and 21B. FIG. 21A is a graph 226 of experimental Raman spectra of semen dried on a polyester substrate. FIG. 21B is a graph 228 of experimental Raman spectra of semen dried on a glass substrate.

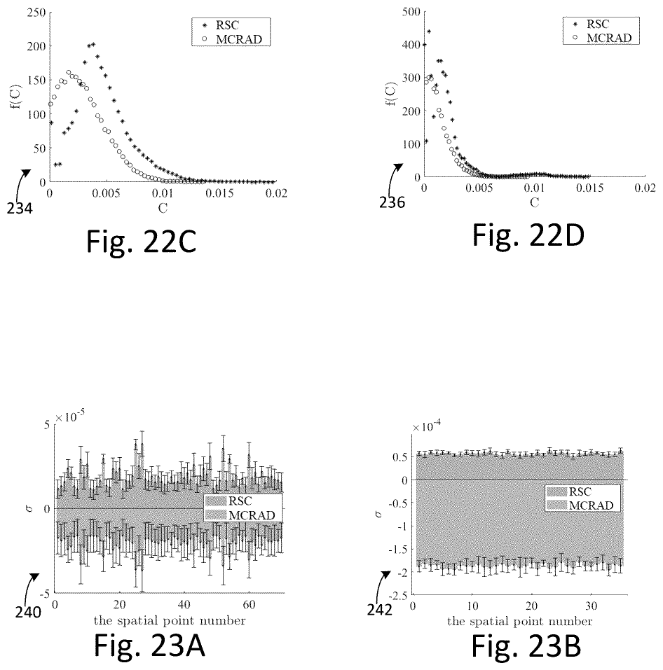

The set of 824 Raman spectra of a semen dried on an aluminum substrate (see FIG. 16C) was used as a reference. The example of the distribution density of a semen VF in a certain spatial point on the polyester and the glass substrate restored by MCRAD and RSC are shown in FIGS. 22A and 22B. FIG. 22A is a graph 230 of a restored semen VF distribution density at a certain spatial point by MCRAD (light) and RSC (dark) on a polyester substrate. FIG. 22B is a graph 232 of a restored semen VF distribution density at a certain spatial point by MCRAD (light) and RSC (dark) on a glass substrate. This distribution was presented as a histogram of 60 C-value subintervals

The same distribution density averaged over all studied points on the substrate surface is shown in FIGS. 22C and 22D. FIG. 22C is a graph 234 of the semen VF distribution density averaged over all studied points on a polyester substate surface restored by MCRAD (light) and RSC (dark). FIG. 22D is a graph 236 of the semen VF distribution density averaged over all studied points on a glass substrate surface restored by MCRAD (light) and RSC (dark).

The evaluated semen VF spatial distribution density on the substrate is followed by the comparisons of FIGS. 22A-22D, to be very inhomogeneous. The RSC established this distribution as multimodal. This is due to the fact that the amount of semen differs at different points on a substrate surface.

The MCRAD drawbacks are that the corresponding VF distribution density support in a particular spatial point has a negative part with no physical sense and that this distribution is more widespread compared to the RSC application results. The mean value and the standard deviation (StDs) of the semen VF at a spatial point with its maximum value on a polyester and a glass substrate are shown in Table 2.

TABLE 2

| | Semen on a polyester substrate | | Semen on a glass substrate | |
|---|---|---|---|---|
| Method | Mean value | StD | Mean value | StD |
| RSC | 0.0106 | 0.002 | 0.0101 | 0.001 |
| MCRAD | 0.0063 | 0.002 | 0.002 | 0.001 |

To check the quality of the restoration of semen C_{ref} and substrate C_{blank} VFs, after their evaluation, we composed a Raman spectrum.

$${S}_{mix} ( k ) = {C}_{blank} {S}_{blank} ( k ) + {C}_{ref} {S}_{ref} ( k ) ,$$

where C_{ref}, C_{blank} are the restored VFs of the semen and the substrate, correspondingly; S_{ref} is a reference Raman spectrum of semen on an aluminum substrate used as an input data for the RSC/MCRAD algorithm, and S_{blank} is the Raman spectrum of the substrate restored by the RSC/MCRAD. The benchmark of the C_{ref} and C_{blank} values restoration accuracy σ was chosen as follows:

$$σ = \sqrt{\frac{{{\sum }_{i} [ {S}_{mix} ( {k}_{i} ) - {S}_{exp} ( {k}_{i} ) ]}^{2}}{n}} .$$

Here, Sₑₓₚ is the analyzed experimental Raman spectrum of n dimension. We used the normalization conditions:

$$\int {S}_{mix} ( k ) dk = \int {S}_{blank} ( k ) dk = \int {S}_{ref} ( k ) dk = 1 , {C}_{blank} + {C}_{ref} = 1 .$$

The averaged values of σ for every spatial point on the polyester (70 points) and glass (35 points) substrates are presented in FIG. 23A-23B.

FIG. 23A is a graph 240 of average values of a at various spatial points on a sample of a semen stain on a polyester substrate. FIG. 23B is a graph 242 of average values of σ at various spatial points on a sample of a semen stain on a glass substrate. The averaging was conducted over all combinations of 824 reference Raman spectra of a semen with 30 Raman spectra of the pure polyester substrate or 9 Raman spectra of the pure glass substrate.

Let us introduce a probability of the method to restore C_{ref}, C_{blank} true VFs, which gives the “accurate” decomposition of the analyzed experimental Raman spectrum Sₑₓₚ as follows:

$${P}_{RSC} = \frac{\frac{1}{{σ}_{RSC}}}{\frac{1}{{σ}_{RSC}} + \frac{1}{{σ}_{MCRAD}}} , {P}_{MCRAD} = \frac{\frac{1}{{σ}_{MCRAD}}}{\frac{1}{{σ}_{RSC}} + \frac{1}{{σ}_{MCRAD}}} .$$

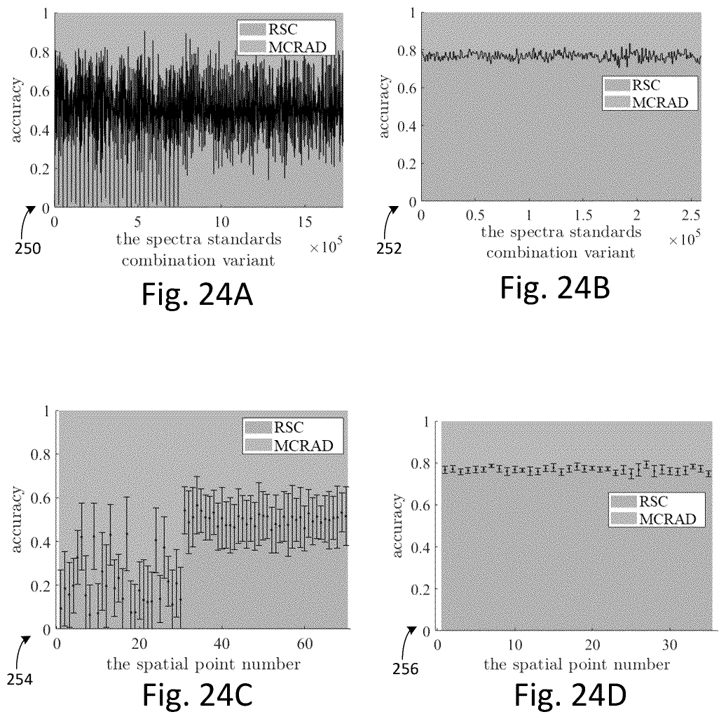

An estimation of the probability of restoring C_{ref}, C_{blank} true VFs by the RSC/MCRAD, using every combination of a standard Raman spectrum of semen with a Raman spectrum of a pure substrate is shown in FIGS. 24A-24B. FIG. 24A is a graph 250 of an estimation of the probability of restoring C_{ref}, C_{blank} true VFs by the RSC/MCRAD, using every combination of a reference semen Raman spectrum with a Raman spectrum of a pure polyester substrate. FIG. 24B is a graph 252 of an estimation of the probability of restoring C_{ref}, C_{blank} true VFs by the RSC/MCRAD, using every combination of a reference semen Raman spectrum with a Raman spectrum of a pure glass substrate.

The same estimates for all spatial points on the polyester (70 points) and glass (35 points) substrates are shown in FIGS. 24C-24D. FIG. 24C is a graph 254 of an estimation of the probability of restoring C_{ref}, C_{blank} true VFs by the RSC/MCRAD at various spatial points on a sample of a semen stain on a polyester substrate. FIG. 24D is a graph 256 of an estimation of the probability of restoring C_{ref}, C_{blank} true VFs by the RSC/MCRAD at various spatial points on a sample of a semen stain on a glass substrate.

Taking into account that P_{RSC}+P_{MCRAD}=1, it can be concluded that, in average, probability to predict a correct result provided by the RSC is of 4 times higher compared to the MCRAD for the case of a pure glass substrate. For the case of a pure polyester substrate, the superiority of the RSC over the MCRAD is not so obvious. The reason can be associated with very high spatial variability of the dried semen sample on the pure polyester substrate. It also can be manifest in high variation of the experimental Raman spectra of this sample.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system to perform spectroscopic analysis on a fluid sample on an interfering substrate, comprising:
a Raman spectrometer, including:
a body, including:
a computer platform in selective communication with other computer devices;
a spectrometer selectively receiving and recording a light scatter;
a laser selectively projecting a sensing laser light;
a focusing optic through which passes the sensing laser light and the light scatter; and
a processor in selective communication with the computer platform of the body across a network,
wherein the spectrometer selectively probes a remote fluid sample on a substrate that produces interfering light scatter thereby obtaining spectroscopic data therefrom that contains the interfering light scatter, and the spectrometer further relays the spectroscopic data to the processor for analysis, and
wherein the processor further configured to isolate the interfering light scatter from the spectroscopic data to thereby produce chemical analysis data for the fluid sample.

2. The system of claim 1, wherein the processor further configured to produce chemical analysis data by including the interfering light scatter as a component with the chemical analysis data.

3. The system of claim 2, wherein the processor further configured to perform a multivariate curve resolution on the spectroscopic data based on a bilinear model of a complex mixture spectrum.

4. The system of claim 2, wherein the processor further determines a component concentration in the spectroscopic data from a predetermined IR absorption spectrum of a complex gas mixture.

5. The system of claim 1, further including a data store in selective communication with the processor and the computer platform of the spectrometer.

6. The system of claim 1, wherein the fluid sample is human blood and the processor further configured to produce chemical analysis data for human blood.

7. The system of claim 1, wherein the fluid sample is human semen and the processor further configured to produce chemical analysis data for human semen.

8. The system of claim 1, wherein the processor further configured to produce chemical analysis data by including the interfering light scatter as a component with the chemical analysis data.

9. The system of claim 1, wherein the processor is located remotely from the spectrometer.

10. A method of utilizing Raman spectroscopy to detect and identify human body fluids within a fluid sample on a light scattering substrate, comprising:
scanning a fluid sample with a portable Raman spectrometer having a body thereof including a computer platform in selective communication with other computer devices across a network, the Raman spectrometer selectively receiving and recording a light scatter from a laser selectively projecting a sensing laser;
collecting spectroscopic data from a fluid sample at the computer platform of the spectrometer, the fluid sample upon a light scattering substrate;
transmitting the spectroscopic data from the computer platform of the spectrometer to a processor across a network, the processor in selective communication with the computer platform of the body across the network;
analyzing the received spectroscopic data at the processor; and
isolating, at the processor, an interfering light scatter from the spectroscopic data to thereby produce chemical analysis data for the fluid sample.

11. The method of claim 10, further including communicating chemical analysis data from the processor to the computer platform of the spectrometer.

12. The method of claim 10, further comprising, at the processor, producing chemical analysis data by including the interfering light scatter as a component with the chemical analysis data.

13. The method of claim 12, further comprising performing a multivariate curve resolution on the spectroscopic data based on a bilinear model of a complex mixture spectrum.

14. The method of claim 12, further comprising determining a component concentration in the spectroscopic data from a predetermined IR absorption spectrum of a complex gas mixture.

15. The method of claim 10, further storing the chemical analysis data at a data store in selective communication with the processor.

16. The method of claim 10, wherein the fluid sample is human blood and the producing chemical analysis data is producing chemical analysis data for human blood.

17. The method of claim 10, wherein the fluid sample is human blood and the producing chemical analysis data is producing chemical analysis data for human blood.

18. The method of claim 10, wherein, at the processor, producing chemical analysis data by including the interfering light scatter as a component with the chemical analysis data.

19. The method of claim 10, further comprising storing chemical analysis data at the data store.

20. A device for detecting human body fluid traces in a fluid sample on an interfering substrate, comprising:
a body, including:
a computer platform in selective communication with a network;
a spectrometer selectively receiving and recording a light scatter;
a laser selectively projecting a sensing laser light;
a focusing optic through which passes the sensing laser light and the light scatter; and
wherein the spectrometer projects the sensing laser light to selectively probe a remote fluid sample on a substrate that produces interfering light scatter, the spectrometer thereby obtaining spectroscopic data therefrom that contains the interfering light scatter, and the spectroscopic data is relayed to the computer platform for analysis, and
wherein the computer platform further configured to isolate the interfering light scatter from the spectroscopic data to thereby produce chemical analysis data for the fluid sample.
